(19) United States
(12) Patent Application Publication
(10) Pub. No.: US 2026/0066704 A1
(43) Pub. Date: Mar. 5, 2026

(54) APPARATUS FOR WIRELESS TRANSMISSION OF POWER AND/OR DATA IN HIGH-PRESSURE ENVIRONMENTS

(71) Applicant: Blue Logic AS, SANDNES (NO)

(72) Inventor: Lars Gunnar HODNEFJELL, MOSTERØY (NO)

(73) Assignee: Blue Logic AS, SANDNES (NO)

(21) Appl. No.: 19/106,864

(22) PCT Filed: Aug. 29, 2023
(86) PCT No.: PCT/NO2023/060039

§ 371 Date: Feb. 26, 2025

(30) Foreign Application Priority Data
Aug. 29, 2022 (NO) 20220927

(51) Int. Cl. H02J 50/10; H02J 50/00; H02J 50/90; H04B 5/26; H04B 5/79

(52) U.S. Cl. CPC H02J 50/10; H02J 50/005; H02J 50/90; H04B 5/266; H04B 5/79

(57) ABSTRACT

An apparatus is for wireless communications in a high-pressure environment having a housing, wherein the housing includes an induction interface, a base portion, a wall section and an internal region, wherein the wall section connects the induction interface and the base portion, and at least one primary induction coil arranged inside the internal region, wherein the induction interface includes a layer of any one of a glass material, a glass-ceramic material and a ceramic material.

### CROSS-REFERENCE TO RELATED APPLICATIONS

This application is the U.S. national stage application of International Application No. PCT/NO2023/060039, filed Aug. 29, 2023, which international application was published on Mar. 7, 2024, as WO 2024/049302 in the English language. The International Application claims priority to Norwegian Patent Application No. 20220927 , filed Aug. 29, 2022. The international application and Norwegian application are both incorporated herein by reference, in their entirety.

### FIELD

The invention relates to wireless transmission of power and/or data in high-pressure environments, for example to an induction apparatus for use in a subsea environment.

### BACKGROUND

Subsea vehicles such as ROVs (Remote Operated Vehicles) and AUVs (Autonomous Underwater Vehicles) are increasingly used to perform various operations subsea. There is thus an increasing need to communicate power and/or data wirelessly between a subsea structure and subsea vehicles.

It is known to use inductive connections subsea for transmission of electric power and communication data. Electrical components of the inductive connections are typically sealed within a housing to avoid contact with the surrounding seawater. Inductive connections typically have an interface separating the electrical components of the connections from the surrounding seawater. The interface is typically formed of a non-conductive and non-corrosive material comprising a polymer material such as plastic, PVDF, PCTFE etc. Polymer-based materials are used due to their material properties, notably their flexibility and resilience. One of the drawbacks with using a polymer material subsea is that, over time, water may migrate through the interface which can lead to increased humidity and/or free water within the electrical connections. This may corrupt the electrical components by, for example, causing corrosion within the connections. Hence, the lifetime of inductive connections can be reduced. Repair or replacement of broken inductive connections require time-consuming and costly subsea operations. For this reason, the development of robust and durable inductive connections suitable for use in high-pressure environments, and in particular underwater applications, for example sub-sea applications, is desired.

In this document, the term subsea can refer to either a saltwater or a freshwater environment.

The invention has for its object to remedy or to reduce at least one of the drawbacks of the prior art, or at least provide a useful alternative to prior art.

The object is achieved through features, which are specified in the description below and in the claims that follow.

### SUMMARY

In a first embodiment, the invention relates to an apparatus for wireless communications in a high-pressure environment comprising:
a housing comprising an induction interface, a base portion, a wall section and an internal region, wherein the wall section connects the induction interface and the base portion; and
at least one primary induction coil arranged inside the internal region, wherein the induction interface comprises a layer comprising any one of a glass material, a glass-ceramic material and a ceramic material.

The layer may comprise a glass material. The layer may comprise a glass-ceramic material. The layer may comprise a ceramic material.

The high-pressure environment may be any one of a: subsea environment; oil tank; water tank; gas tank; high-pressure reservoir, etc. The high-pressure environment has a pressure that is higher than atmospheric pressure. The high-pressure environment may have a pressure that is higher than the gas pressure inside housing. The high-pressure environment may have a pressure two times the atmospheric pressure. The high-pressure environment may have a pressure 10 times the atmospheric pressure. The high-pressure environment may have a pressure 50 times the atmospheric pressure. The high-pressure environment may have a pressure 100 times the atmospheric pressure. The high-pressure environment may have a pressure 300 times the atmospheric pressure.

An advantage of using an induction interface comprising a layer comprising any one of a glass material, a glass-ceramic material and a ceramic material, is that it can significantly increase the lifetime of the apparatus when used in a high-pressure environment, particularly in a subsea environment, as the diffusion rate of fluids becomes significantly lower than for polymetric, or plastic based induction interfaces.

The internal region may comprise a support material for providing pressure support to the induction interface.

The support material may comprise a solid and non-conductive material.

The support material may comprise a ferrite material.

The support material may comprise a curable material.

The curable material may comprise any one or more of the following: epoxy-based materials; polymer materials; thermoplastic materials; and concrete materials.

The support material may be arranged to contact and support the induction interface, and to contact and be supported by a support face when the apparatus is placed in a high-pressure environment. The support face may comprise a face of the base portion.

An advantage of the support material is that it may prevent breakage of the ceramic layer by providing support from inside the housing. Using a solid is further advantageous in that the solid may give greater pressure support than gas of liquids. Using a support material comprising a ferrite material is advantageous in that it may provide a magnetic shield protecting electrical components.

The wall section of the housing may comprise a resilient compression means extending around a circumference of the internal region. The compression means may be arranged to facilitate a compression of the internal region by allowing movement of the ceramic layer towards the base portion. The resilient compression means may advantageously facilitate movement of the whole ceramic layer towards the base portion, so that the support material may be further compressed to give an increased support to the ceramic layer.

The apparatus may comprise a cavity between the base portion and the internal region. The cavity may be separated from the internal region by a flexible plate being sealingly attached to a circumference of a lower portion of the wall section. The cavity may further comprise a fluid passage connecting the high-pressure environment and the cavity.

The flexible plate may provide a sealing towards the internal region. The support material may be arranged to contact and be supported by the flexible plate. The support face may comprise the flexible plate.

An effect of the cavity is that, in use, the cavity is pressurised by the high-pressure surroundings. The pressure biases the flexible plate towards the ceramic layer, thereby providing additional support to the support material and hence providing additional support to the ceramic layer.

In a second embodiment, the invention relates to a system for wireless communication between a subsea structure and a subsea vehicle. The system may comprise the apparatus according to the first embodiment. The system may comprise the subsea structure comprising means for providing electric power and data to the apparatus.

The system may include a subsea vehicle comprising at least one secondary induction coil for receiving power from the apparatus. The subsea vehicle may comprise at least one secondary induction coil for communicating data with the apparatus.

In a third embodiment, the invention relates to a method of transmitting power and/or data in a high-pressure environment. The method may comprise providing the apparatus according to the first embodiment in the high-pressure environment. The method may comprise providing a vessel or vehicle. The method may comprise positioning and locating the vessel or vehicle close to the induction interface. The method may comprise transmitting power and/or data between the apparatus and the vessel or vehicle wirelessly through the induction interface.

The method may further comprise using at least one of the at least one induction coils to induce an electromagnetic field. The method may comprise receiving the electromagnetic field by use of at least one secondary induction coils at the vehicle. The method may comprise providing a communication device in or adjacent to the high-pressure environment and transferring data and power from the communication device to the apparatus.

The vessel or vehicle may be a subsea vehicle. The vessel or vehicle may be a subsea vessel.

### BRIEF DESCRIPTION OF THE DRAWINGS

There will now be described, by way of examples only, embodiments of the invention, with reference to the accompanying drawings, in which:

FIG. 1 shows a first perspective view of a first example induction capsule;

FIG. 2 shows a first side view of the first example induction capsule;

FIG. 3 shows a first cross-sectional view of the first example induction capsule attached to a subsea structure;

FIG. 4 shows a first cross-sectional view of a second example induction capsule; and

FIG. 5 shows a first cross-sectional view of a third example induction capsule comprising a cavity.

### DETAILED DESCRIPTION OF THE DRAWINGS

Any positional and directional indications refer to the position shown in the figures.

In the figures, same or corresponding elements are indicated by same reference numerals. For clarity reasons, some elements may in some of the figures be without reference numerals.

A person skilled in the art will understand that the figures are just principal drawings. The relative proportions of individual elements may also be distorted.

The invention relates to an apparatus for wireless transmission of power and data, sub-sea, hereafter called an induction capsule 100.

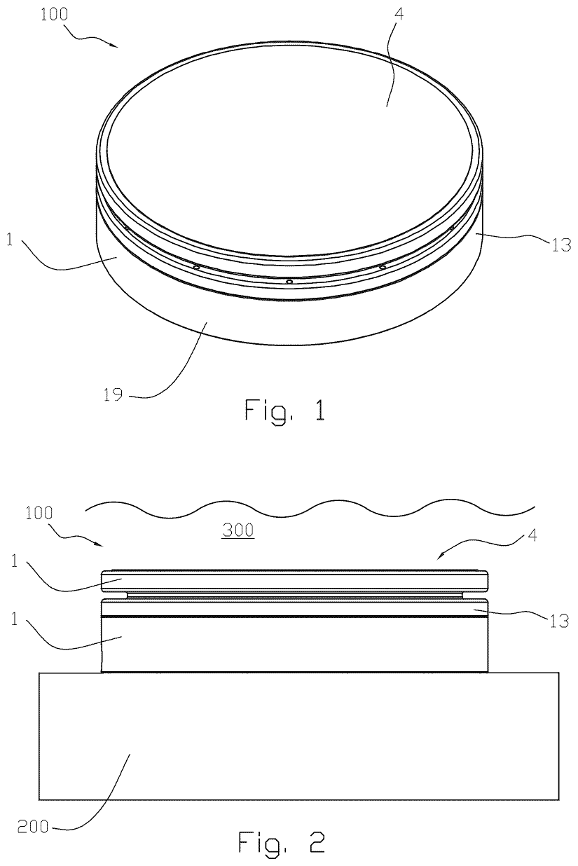

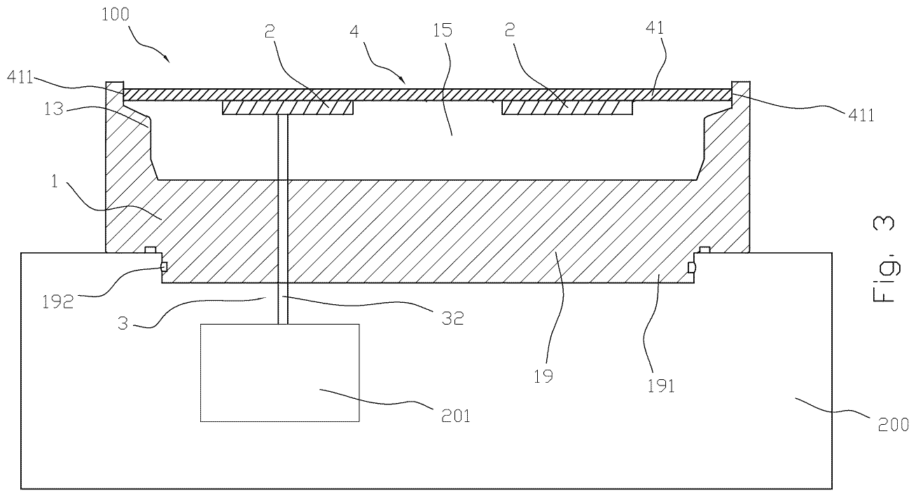

FIG. 1 shows an example of the induction capsule 100 comprising a housing 1. The housing 1 comprises an induction interface 4, a wall section 13, and a base portion 19 (best shown in FIG. 3). The wall section is ring-shaped and encloses an internal region 15 (shown in FIG. 3). The internal region 15 is defined in an upper end by the induction interface 4 and in a lower end by the base portion 19.

The induction capsule 100 is arranged to be coupled to a power and data source. The power and data source can be a subsea structure 200 (indicated by a box shaped structure in FIGS. 2 and 3). The induction capsule shown in the figures are arranged to be fixed onto a subsea structure 200 supplying the induction capsule 100 with power and data. Mounted onto a subsea structure 200, the housing 1 and the subsea structure 200 are for ensuring that the internal region 15 is sealed against a surrounding high-pressure environment, in FIG. 2 shown as a subsea environment 300. As will be described later, the induction capsule 100 comprises means for wireless communication of power and data to e.g., a subsea vehicle (not shown).

In use, typically, a subsea vehicle is navigated onto or close to the induction interface 4, and power and/or data is transmitted to the vehicle by way of an electromagnetic field induced by the induction capsule 100. The induction capsule 100 may also receive data by way of an electromagnetic field generated or transmitted on or by the subsea vehicle. As will be described below, the induction capsule 100 comprises a primary induction coil able to transmit and receive the electromagnetic field. In the same way, the subsea vehicle comprises at least one secondary induction coil (not shown) for receiving and/or generating or transmitting the electromagnetic field.

FIG. 3 shows a cross-section of one embodiment of the induction capsule 100 connected to the subsea structure 200. The housing 1 is made of stainless steel. The wall section 13 partially encloses the internal region 15 of the housing 1. The induction interface 4 shown, comprises a circle-shaped, non-conductive ceramic plate 41. A circumference 411 of the ceramic plate 41 is fused to an internal portion of the wall section 13 by a glass-to-metal sealing process to form a tight sealing. The base portion 19 provides an enclosure of the internal region 15 in a lower end. A primary induction coil 2 is positioned inside the internal region 15 adjacent the induction interface 4. The base portion 19 further comprises an attachment means 191 for attaching the housing 1 to the subsea structure 200. An O-ring 192 forms a tight seal between the subsea structure 200 and the induction capsule 100.

The subsea structure 200 in the example is shown schematically and comprises a power and communication module 201 for communicating power and communication data to the induction capsule 100 via a communication means 3. In the figure, the communication means 3 is shown as a cable 32 providing an electrical connection between the induction capsule 100 and the subsea structure 200.

In other embodiments, the induction capsule 100 is connected to the power and data source via a cable, and not fixedly mounted to a subsea structure as shown in the figures. Hence, the power and data source may be placed apart from the induction capsule 100. In some arrangements, the induction capsule 100 is positioned in the sea and receives power and data from a surface vessel via a cable connecting them.

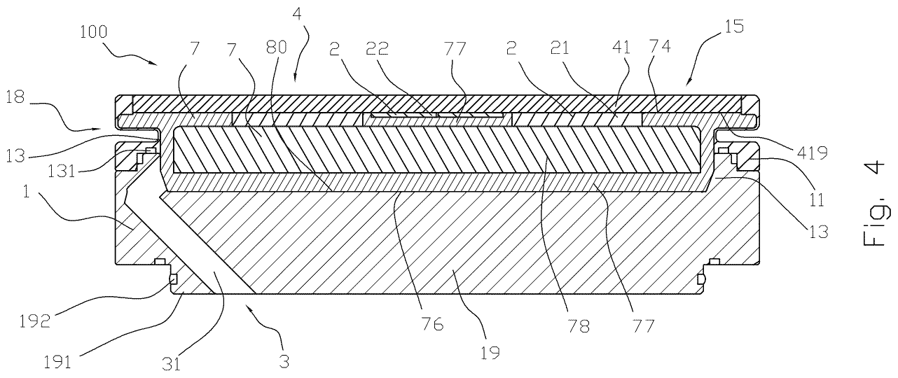

Another embodiment of the induction capsule 100 is shown in FIG. 4. The induction capsule 100 shown is further adapted for use in a high-pressure environment, such as deep waters. In the figure the wall structure 13 and the base portion 19 are two separate pieces connected via a bolted connection 131. The ceramic plate 41 is connected to a top portion 11 of the wall section 13. The base portion 19 comprises the attachment means 191 with an O-ring 192 for connection to the subsea structure 200. The O-ring 192 ensures that the connection is tight. The induction capsule 100 further comprises two primary induction coils 2: a power coil 21 for transmitting and receiving power to/from sub-sea vehicles and a communication coil 22 for transferring communication data with the subsea vehicles. The communication means 3 is in this embodiment shown as a channel 31 through the base portion 19 for housing electrical cables (not shown) connecting the primary induction coils 2 and the subsea structure 200.

The induction capsule 100 further comprises a solid support material 7 inside the internal region 15. The support material 7 forms a first face 74 and a second face 76. The first face 74 abuts and supports an inside 419 of the ceramic plate 41. The support material 7 fills a remainder of the internal region 15 not occupied by the primary induction coils 2, thereby supporting and holding the coils 2 close to the ceramic plate 41. The second face 76 abuts a support face 80. In this embodiment the support face comprises an upper face of the base portion 19. Hence, the support material 7 provides internal support to the ceramic plate 41, thereby preventing breakage when used in high-pressure environments 300.

In one embodiment, the support material 7 comprises a disc-formed centre portion 78 consisting of a ferrite material, and an envelope 77 comprising an epoxy material. The ferrite material provides an electromagnetic shield between the primary induction coils 2 and the subsea structure 200. The epoxy filling is a solid, non-conductive material that fills the remainder of the internal region 15.

In use, water pressure biases the ceramic plate 41 against the support material 7. The support material 7 provides a force acting on the ceramic plate 41 in an outwards direction, thereby preventing breakage.

To further prevent the ceramic plate 41 from breaking, the wall section 13 is shown comprising a resilient compression means 18 for allowing a movement of the ceramic plate 41 towards the base portion 19, resulting in a compression of the internal region 15. The compression means 18 is best seen in FIG. 4, showing the compression means 18 with an s-shaped profile. The resilience of the compression means 18 is obtained by a centre-portion of the s-shaped profile 18 being thinner than a top and bottom portion, as shown in FIG. 4. The s-shaped profile extends along a circumference of the wall section 13.

When used in high-pressure environments, the s-shaped compression means 18 allows a further inwards movement towards the base portion 19 of the ceramic plate 41. The result is that the support material 7 is further compressed, giving a greater force acting on the ceramic plate 41 in the outwards direction. In this way, the ceramic plate 41 is supported more evenly than in embodiments not having the compression means 18.

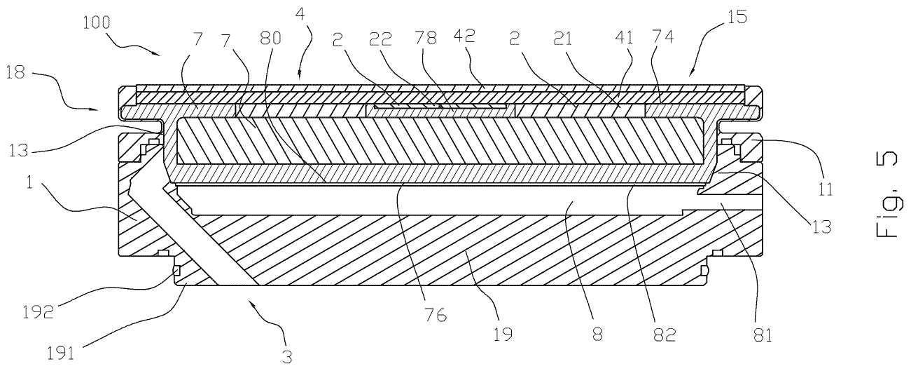

Another embodiment is shown in FIG. 5. The induction capsule 100 shown comprises a cavity 8 positioned between the base portion 19 and the internal region 15. The cavity 8 is separated from the internal portion 15 by a flexible metal plate 82. A circumference of the metal plate 82 is fused along an inside of the wall section 13 to form a tight sealing between the cavity 8 and the internal region 15. The cavity 8 further has a channel 81 for communicating water between the cavity 8 and the subsea environment 300. In this embodiment, the support face 80 comprises the flexible metal plate.

When placed in a subsea environment, the cavity 8 is filled with water, and the pressure within the cavity 8 is equal to the pressure of the subsea environment. The metal plate 82 is biased towards the ceramic plate 41 by the seawater in the same manner that the seawater biases the ceramic plate 41 towards the metal plate 82 and the base portion 19. This way, the support material 7 receives additional support from the cavity 8 via the flexible metal plate 82. Hence, additional support is given to the ceramic plate 41 via the support material 7.

The induction interface 4 may further comprise a cover 42 protecting the outer surface of the ceramic plate 41. The cover 42 can be a non-conductive material made of a polymer material.

The induction capsule may also be used in other high-pressure environments such as inside oil and gas tanks, oil and gas reservoirs, etc.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

The mere fact that certain measures are recited in mutually different dependent claims does not indicate that a combination of these measures cannot be used to advantage.

1. An apparatus for wireless communication in a high-pressure environment comprising:
a housing comprising an induction interface, a base portion, a wall section, and an internal region, wherein the wall section connects the induction interface and the base portion; and
at least one primary induction coil arranged inside the internal region, wherein the induction interface comprises a layer comprising any one of a glass material, a glass-ceramic material and a ceramic material, and
wherein the wall section further comprises a resilient compression means extending around a circumference of the internal region, the compression means being arranged to facilitate a compression of the internal region by allowing movement of the induction interface towards the base portion.

2. The apparatus according to claim 1, wherein the internal region of the housing 1 comprises a support material for providing pressure support to the induction interface

3. The apparatus according to claim 2, wherein the support material comprises a solid and non-conductive material.

4. The apparatus according to claim 3, wherein the support material comprises a ferrite material.

5. The apparatus according to claim 3, wherein the support material comprises a curable material.

6. The apparatus according to claim 5, wherein the curable material comprises any one or more of the following: epoxy-based materials; polymer materials; thermoplastic materials; and concrete materials.

7. The apparatus according to claim 3, wherein the support material is arranged to contact and support the induction interface and to contact and be supported by a support face when the apparatus is placed in a high-pressure environment.

8. (canceled)

9. The apparatus according to claim 2, wherein the apparatus further comprises a cavity between the base portion and the internal region, wherein the cavity is separated from the internal region by a flexible plate being sealingly attached to a circumference of a lower portion of the wall section, the cavity further comprising a fluid passage connecting the high-pressure environment and the cavity.

10. The apparatus according to claim 1, wherein the high-pressure environment comprises a subsea environment.

11. A system for wireless communication between a subsea structure and a subsea vehicle comprising:
the apparatus according to claim 1;
a subsea structure comprising means for providing electric power and data to the apparatus.

12. A method of wireless transmission of power and/or data in a high pressure environment, the method comprising the steps of:
providing the apparatus according to claim 1 in the high-pressure environment;
providing a movable vessel or vehicle;
positioning and locating the vessel or vehicle close to the induction interface;
transmitting power and/or data between the apparatus and the vehicle wirelessly through the induction interface.

13. A method according to claim 121 further comprising the steps of:
providing a communication device in or adjacent to the high-pressure environment; and
transmitting data and power from the communication device to the apparatus.

14. The apparatus according to claim 4, wherein the support material comprises a curable material.

15. The apparatus according to claim 4, wherein the support material is arranged to contact and support the induction interface, and to contact and be supported by a support face when the apparatus is placed in a high-pressure environment.

16. The apparatus according to claim 5, wherein the support material is arranged to contact and support the induction interface, and to contact and be supported by a support face when the apparatus is placed in a high-pressure environment.

17. The apparatus according to claim 6, wherein the support material is arranged to contact and support the induction interface, and to contact and be supported by a support face when the apparatus is placed in a high-pressure environment.
